(19) United States
(12) Patent Application Publication
(10) Pub. No.: US 2014/0048265 A1
(43) Pub. Date: Feb. 20, 2014

(54) COHESIVE SETTABLE CEMENT SYSTEM

(71) Applicant: CSI Technologies, LLC, Houston, TX (US)

(72) Inventors: N. Kyle Combs, Spring, TX (US); Larry Watters, Spring, TX (US); Fred Sabins, Montgomery, TX (US)

(21) Appl. No.: 13/944,451

(22) Filed: Jul. 17, 2013

Related U.S. Application Data
(60) Provisional application No. 61/672,643, filed on Jul. 17, 2012.

(51) Int. Cl. C09K 8/42; E21B 33/13; E21B 33/16

(52) U.S. Cl. CPC C09K 8/426; E21B 33/16; E21B 33/13
USPC 166/292; 166/90.1; 106/815; 106/600; 106/628; 106/638

(57) ABSTRACT

A lightweight cross-linked gelled settable cement fluid system derived by pre-hydrating a water gelling agent, and then using that to mix with a cement blend which results in a very stable cement blend, which will matriculate through any fluid and not disperse, and form a cohesive plug wherever it comes to rest; wherein the fluid is injected at the bottom of the 10 pound/gal brine, and the fluid rises to the top of the brine where it reforms into a cohesive plug and hardens; and wherein the fluid can be applied to any density solution, and provide stability and cohesiveness to any settable plug; and wherein the cement/gelled water mixture is then cross-linked using standard hydraulic fracturing cross-linkers to provide a stable structure and ability to matriculate through another fluid and not disperse into that fluid. In a second embodiment the lightweight cross-linked gelled settable cement fluid which is cohesive and stable to be used as a balanced plug during cementing procedures to avoid the plug from becoming dilute in order to develop compressive strength, prevent fluid interchange from occurring and ensuring that all the cement placed would set in place.

### CROSS-REFERENCE TO RELATED APPLICATIONS

This is a nonprovisional patent application of U.S. Provisional Patent Application Ser. No. 61/672,643, filed Jul. 17, 2012, entitled “COHESIVE SETTABLE CEMENT SYSTEM”, by the same inventors, which is hereby incorporated herein by reference.

Priority of U.S. Provisional Patent Application Ser. No. 61/672,643, filed Jul. 17, 2012, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to the oilfield. More particularly, the present invention relates to a cement system comprised of commonly used materials from different areas within the oilfield industry such as cementing, production, and stimulation.

2. General Background of the Invention

In the oilfield industry, the system of the present invention arose from the specific need to develop a stable, cohesive, lightweight settable material that could be pumped into a cavern filled with 10 pound/gal. brine, rise through that brine to the top of the cavern, and develop compressive strength once in a static environment at the top of the cavern. Lightweight settable systems have been developed before, but they are usually unstable in the presence of large volumes of diluting fluid and they normally do not develop good compressive strength. In this scenario, standard lightweight systems would not work because of the need to matriculate through the brine to the top of the cavern. All other lightweight settable systems known to the inventors will disperse on contact with the brine and a solid cohesive plug would likely never form.

### BRIEF SUMMARY OF THE INVENTION

The apparatus, system and method of the present invention solves the problems confronted in the art in a simple and straightforward manner. What is provided is a lightweight cross-linked gelled settable cement system comprised of commonly used materials from different areas within the oilfield industry such as cementing, production, and stimulation. These materials formulated in novel combinations and concentrations outside known operating ranges produce the unique cohesive material that sets to form a wellbore seal. The cross-linked, gelled fluid is derived by pre-hydrating a water gelling agent, and then using that to mix with a cement blend containing density modification additives and a particulate substance containing borate. The result is a very stable cement blend, which will matriculate through any fluid and not disperse, and form a cohesive plug wherever it comes to rest.

In a second embodiment using the same cross-linked gelling techniques, the cement has been replaced with sodium silicate to produce a plug capable of floating on a 10 lb/gallon brine. This cohesive settable sodium silicate formulation is proven capable of being injected into a brine, floating to the top of that brine, and then reforming into a cohesive plug at the top of the brine.

This method can also be done with a cement or sodium silicate solution heavier than the well fluid by adding heavy-weight density-adjusting additives, for example barite or hematite. This slurry will sink to the bottom of the well fluid and form a cohesive plug. This is done by hydrating guar, adding cement or sodium silicate blend, and then cross linking the mixture to obtain a cohesive fluid capable of being injected or placed in another fluid and not dispersing.

In another embodiment cross-linking materials with properties similar to borate or boron are used to create a lightweight cross-linked gelled settable cement or sodium silicate system.

One embodiment of the system of the present invention comprises a cross-linked gelled settable cement fluid system derived by pre-hydrating a water gelling agent, and then using that to mix with a cement blend comprising density modification additives and a particulate substance containing borate which results in a very stable cement blend, which will matriculate through any fluid and not disperse, and form a cohesive plug wherever it comes to rest.

In another embodiment of the system of the present invention, the fluid is injected at the bottom of 10 pound/gal brine, and the fluid rises to the top of the brine where it reforms into a cohesive plug and hardens.

In another embodiment of the system of the present invention, the fluid can be applied to any density solution, and provide stability and cohesiveness to any settable plug.

In another embodiment of the system of the present invention, the cement/gelled water mixture is then cross-linked using standard hydraulic fracturing cross-linkers to provide a stable structure and ability to matriculate through another fluid and not disperse into that fluid.

Another embodiment of the system of the present invention comprises a cross-linked gelled settable cement fluid which is cohesive and stable to be used as a balanced plug during cementing procedures to avoid the plug from becoming dilute in order to develop compressive strength, prevent fluid interchange from occurring and ensure that all the cement placed would set in place.

Another embodiment of the system of the present invention comprises a lightweight cross-linked gelled settable cement fluid system used during cementing procedures which is stable and cohesive when injected into a salt solution and develops approximately 300 to 400 psi of compressive strength in 24 hours and close to 500 psi at 48 hours.

Another embodiment of the system of the present invention comprises a cross-linked gellable settable sodium silicate solution able to produce a plug capable of floating on a 10 lb/gal brine, which is capable of being injected into a brine, flow to the top of the brine and then reform into a cohesive plug at the top of the brine.

In another embodiment of the system of the present invention, there may be provided a sodium silicate solution heavier than the well fluid which will sink to the bottom of the well fluid and form a cohesive plug.

Another embodiment of the present invention comprises a cross-linked gelled settable fluid system derived by pre-hydrating a water gelling agent, and then using that to mix with sodium silicate solution comprising density modification additives and a particulate substance containing borate which results in a very stable sodium silicate solution, which will matriculate through any fluid and not disperse, and form a cohesive plug wherever it comes to rest.

In another embodiment of the system of the present invention, the fluid is brine and after being injected into the brine the sodium silicate solution floats to the top of the brine and reforms as a cohesive plug.

In another embodiment of the system of the present invention, the brine is 10 lb/gallon brine.

In another embodiment of the system of the present invention, the cement mixture comprises heavy-weight density-adjusting additives so that the hydrated water gelling agent and cement mixture will sink to the bottom of a well fluid, and form a cohesive plug at the bottom where it comes to rest.

In another embodiment of the system of the present invention, the system is derived by adding heavy-weight density-adjusting additives to the sodium silicate solution so that the hydrated water gelling agent and sodium silicate solution will sink to the bottom of a well fluid and not disperse, and form a cohesive plug at the bottom where it comes to rest.

An embodiment of a method of the present invention comprises a method of forming a plug using a cross-linked gelled settable system comprising: a. hydrating a gelling agent; b. adding the gelling agent to a cement blend or sodium silicate solution, wherein the cement blend or sodium silicate solution includes density modification additives and a cross-linking particulate substance; c. adding the mixture of step “b” to any fluid of any density; d. allowing the mixture of step “b” to matriculate through the fluid without dispersing to form a cohesive and stable plug wherever it comes to rest.

In another embodiment of the method of the present invention, the cross-linking particulate substance contains borosilicate bubbles.

In another embodiment of the method of the present invention, the cross-linking particulate substance contains crushed borosilicate glass.

In another embodiment of the method of the present invention, the cross-linking particulate substance comprises lightweight borosilicate bubbles, and the cement blend with the gelling agent is added to a heavier fluid and allowed to matriculate through the fluid wherein the gelling agent and cement blend form a slug of fluid which will not disperse and which will set or seal on top of the heavier fluid.

In another embodiment of the method of the present invention, the cement blend and gelling agent is floated on top of the heavier fluid.

In another embodiment of the method of the present invention, the cement blend and gelling agent is injected into the heavier fluid.

In another embodiment of the method of the present invention, the cross-linking particulate substance comprises borosilicate glass or borosilicate bubble and wherein the method further comprises placing the hydrated gelling agent and cement blend in a fluid of any density wherein the hydrated gelling agent and cement blend does not disperse and will form a plug where it comes to rest.

In another embodiment of the method of the present invention, the hydrated gelling agent and cement blend is pumped into the top of a well or annulus, and allowed to fall through a fluid of lighter density to the top of a packer and allowed to set and seal the top of the packer.

In another embodiment of the system of the present invention, the particulate substance contains crushed borosilicate glass or borosilicate bubbles.

Another embodiment of the system of the present invention comprises a cross-linked gelled settable cement fluid system derived by pre-hydrating a water gelling agent, and then using that to mix with a cement blend comprising density modification additives and a cross-linking particulate substance which results in a very stable cement blend, which will matriculate through any fluid and not disperse, and form a cohesive plug wherever it comes to rest.

### DETAILED DESCRIPTION OF THE INVENTION

In addressing the present invention in greater detail, the fluid which comprises lightweight cross-linked gelled settable cement system is derived by pre-hydrating a water gelling agent, and then using that to mix with a cement blend or some other type of settable material. The result is a very stable system, which will matriculate through any fluid and not disperse, and form a cohesive plug wherever it comes to rest.

In the application of the present invention, the fluid is injected at the bottom portion of the 10 pound/gal brine, and the fluid rises to the top of the brine where it reforms into a cohesive plug and hardens. This cement blend can contain lightweight material, for example 3M Hollow Ceramic Spheres, or other material with similar properties, should there be a need for a lightweight slurry like the one described above, but this novel idea can be applied to any density slurry, and provide stability and cohesiveness to any settable plug. The cement/gelled water mixture is then cross-linked by the borate containing particulates. In some cases, standard hydraulic fracturing cross-linkers can be used as well. It is the cross-linking from the borate containing particulates that provides the stable structure and ability to matriculate through another fluid and not disperse into that fluid.

This concept can be applied to cement systems of any density. There are several scenarios involving the plugging of wells where this could be useful. For example, a slurry of high density, for example 16 lb/gal, could be pumped into the top of a well, and allowed to matriculate down through a well fluid with a lighter density than the cement system design. This could not be done with a normal cement system, as it would disperse into the well fluid as it fell. However, with this concept, this could be performed, and the cement system would fall to the top of a packer or the bottom of a hole, reform into a cohesive plug, and develop compressive strength. This method would eliminate the need to run tubing to the bottom of the well or the top of a packer and pump in a cement slurry that would displace the well fluid, saving the operator thousands of dollars in equipment and time. It also enables placement of cement systems into narrow annular spaces that would be impossible to access with traditional tubing and displacement methods.

Another embodiment of the system is the placement of a balanced plug. During current procedures, a cement system is placed on top of a less dense fluid in a well using tubing so that the cement level inside the tubing is equal to the level outside the tubing. When the tubing is removed, the cement is left to support itself above this less dense fluid. Most of the time, what is known as the Boycott effect is experienced by these cement slurries. What occurs is that due to the more dense cement being on top, fluid from the less dense fluid starts to invade the cement. This causes cement particulates to fall out of the cement and migrate through the fluid below. This circular motion with fluid going up and particles going down begins slowly at first but quickly accelerates to a large volume of interchange occurring. Eventually, a large portion of the plug can become dilute and not develop compressive strength, thus decreasing the overall length of the plug. A fluid using our new system would be cohesive and stable, preventing the fluid interchange from occurring and ensuring that all the cement placed would set in place.

In yet an additional embodiment of the system of the present invention, while using the same cross-linked gelling techniques described in the first embodiment, we have replaced the cement with sodium silicate to produce a plug capable floating on a 10 lb. brine. This cohesive settable sodium silicate formulation has been proven to be capable of being injected into a brine, float to the top of that brine, and then reform into a cohesive plug at the top of the brine. This can also be done with a sodium silicate solution heavier than the brine. This solution will sink to the bottom of the brine and form a cohesive plug. This is once again done by hydrating guar in water, adding sodium silicate, and then cross-linking the mixture to obtain a cohesive fluid capable of being injected or placed into another fluid and not dispersing.

The following are examples of potential applications of the present invention:

### Lightweight Cement System

A gelling agent is hydrated in water, and then added to a cement blend that has had lightweight borosilicate bubbles added to it. This system can be used to float on top of a heavier fluid, or injected into heavier fluid and allowed to float to the top of the heavier fluid, where it will form a slug of fluid which will set or seal at the top of the heavier fluid.

### Balanced Plug

A System in which a gelling agent is gelled in water, and then mixed with a cement blend which contains a particulate made of crushed borosilicate glass. A plug is placed on a heavier fluid, such as water-based drilling fluid, or other fluids having a density of at least 9.0 lb/gal., using tubing so that the level inside and outside the tubing are equal.

### Plug for top of Packers (Weighted System)

Same system as above, but the system is pumped into the top of a well or annulus, and allowed to fall through a fluid of lighter density. The system falls to the top of a packer and allowed to set, thus sealing the top of the packer.

### Squeezable Cement System

A system that can be designed at any density, using either bubbles or crushed particulates, depending upon the density desired. The system by design and being cohesive by nature will have good fluid loss, and there for will make an excellent squeeze material.

### Test Results

In testing to date, all attributes of the invention thought to be obtained have been obtained. Although testing is still in the developmental phase, to date a lightweight system has been developed that is stable and cohesive when injected into a salt solution and develops approximately 300 to 400 psi of compressive strength in 24 hours and close to 500 psi at 48 hours. These compressive strengths are exceptional for the density at which the system is being tested.

In addition of testing which is still in the developmental phase, there has been developed a lightweight sodium silicate solution capable of forming a plug on top of a 10 lb/brine solution. There has also been developed a sodium silicate solution that is heavier than a 10 lb/brine, and therefore when it is injected, it sinks and forms a cohesive plug below the brine.

### Lightweight Testing:

The lightweight testing was done for a specific application. The application included the need for the system we developed to be injected into a cavern filled with 10 lb/gal salt water brine, float to the top of that brine, reform into a plug, and quickly set to seal the top of the cavern. To accomplish this, a vast amount of testing was performed, leading to a successful test that was eventually used in the field in an extremely large cementing operation. The cohesive system developed performed exceptionally well. For this system, lightweight borosilicate glass bubbles were used. The final density of the cohesive system was 8.7 lb/gal, and the bubble concentration was 47% by weight of cement (% bwoc). These tests also included the use of solid sodium metasilicate, used as an accelerator, at a final concentration of 1%. The pre-hydrated gelling agent (guar) concentration was 26 lb/mgal of water. Below are the successful ranges of concentrations for the testing performed on this project.
Basis: 1-94 lb sack of Portland cement
Overall Density: 8.5-9.8 lb/gal
Bubble Concentration: 35-55% bwoc
Guar: 15-40 lb/mgal of water
SMS concentration: 1-6% bwoc

### Standard Density Testing:

This testing was performed to try and determine the application ranges of the material. Several different tests were performed, but at higher densities, there is much less water in the system, and therefore much less gelling agent. Even at densities above 12 or 13 lb/gal, it was difficult to design a cohesive system using the materials we had available. Issues of mixability and overall stability of the cement were experienced. It was during this testing that it was discovered that the type of borosilicate particle and the size of borosilicate particle used is extremely important. At higher densities, it is critical that the borosilicate particles be of a high boron loading and that the majority of the particles be smaller than 74 μm. To date, the following ranges have been successfully tested:
Overall Density: 10-14 lb/gal
Borosilicate Concentration: 20-60% bwoc
Guar: 15-40 lb/mgal of water
   Example Test Mixture for 14 lb/gal Cohesive Slurry:

425.62 g Class H Lehigh Cement+212.81 g of Borosilicate Glass Powder+0.37 g of Liquid Defoamer+2.81 g of Liquid Guar Concentrate (LGC concentrated at 4 lb guar per gallon LGC)+368.11 g Water.

### Procedure:

Mix water, LGC, and defoamer together on a table top mixer under low shear for 30 minutes. Blend cement and glass powder together as a solid. Mix the solid blend in with the water on a Waring blender. Low shear until solids are wet, high shear for 35 seconds.

### Densified Slurries:

To date, with limited testing, no densified slurries have been successfully tested due mostly to mixability issues (ultra-high initial viscosities). The mixability issues stem from the gelled water, as well as the fact that densified slurries have more solids as well as more dense solids. Based on the other testing results, with improved mixing methods and addition of common high-density solid weighting materials such as barite or hematite, it is predicted that one will be able to obtain densities up to 18 lb/gal via improved mixing methods.

### Other Results:

Up to now, it appears that no other additives have made significant impacts upon the cohesive nature of the systems. The systems have been mixed with standard oilfield chemicals such as retarders, antifoams, sodium silicate and sodium metasilicate, calcium chloride, and biocides. Other chemicals such as magnesium oxide have been mixed as well with no major consequences. It is believed that a wide array of standard cementing chemicals can be used at their normal concentrations and have no effect on the cohesiveness of the system.

### CONCLUSIONS

The systems have been tested to be successful from a density range of 8.5 to 14 lb/gal.

The systems require some form of boron based solid particle, with the majority of the particles of its distribution being smaller than 74 μm.

There are no compatibility issues with other oilfield chemicals when used in their normal concentrations.

It is predicted that more dense systems can be designed, but more testing would be required.

It is predicted that addition of material or particulates with similar properties to boron will have similar results.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A cross-linked gelled settable cement fluid system derived by pre-hydrating a cross-linkable water gelling agent, and then using that to mix with a hydraulic cement blend comprising density modification additives and a particulate substance containing borate which results in a very stable hydraulic cement blend, which will matriculate through any fluid and not disperse, and form a cohesive plug wherever it comes to rest.

2. The system in claim 1, wherein the fluid is injected below a heavier fluid such as brine, and the injected fluid rises to the top of the brine where it reforms into a cohesive plug and hardens.

3. The system in claim 1, wherein the fluid can be applied as any density solution, and provide stability and cohesiveness to any settable plug.

4. The system in claim 1, wherein the cement/gelled water mixture is then cross-linked using standard hydraulic fracturing cross-linkers to provide a stable structure and ability to matriculate through another fluid and not disperse into that fluid.

5. A cross-linked gelled settable cement fluid which is cohesive and stable to be used as a balanced plug during cementing procedures to avoid the plug from becoming dilute in order to develop compressive strength, prevent fluid interchange from occurring and ensure that all the cement placed would set in place.

6. A lightweight cross-linked gelled settable cement fluid system used during cementing procedures which is stable and cohesive when injected into a salt solution and develops a minimum of 100 psi compressive strength in 24 hours.

7. A low density cross-linked gellable or settable sodium silicate solution able to produce a plug capable of being injected into a fluid or brine, flow to the top of the fluid or brine and then reform into a cohesive plug at the top of the brine.

8. The system in claim 7, wherein there may be provided a sodium silicate solution heavier than the well fluid which will sink to the bottom of the well fluid and form a cohesive plug.

9. A cross-linked gelled settable fluid system derived by pre-hydrating a cross-linkable water gelling agent, and then using that to mix with sodium silicate solution comprising density modification additives and a particulate substance containing borate which results in a very stable sodium silicate solution, which will matriculate through any fluid and not disperse, and form a cohesive plug wherever it comes to rest.

10. The cross-linked gelled settable fluid system of claim 9 wherein the fluid is brine and wherein after being injected into the brine the sodium silicate solution floats to the top of the brine and reforms as a cohesive plug.

11. (canceled)

12. The cross-linked gelled settable fluid system of claim 1, wherein the cement mixture comprises heavy-weight density-adjusting additives so that the hydrated water gelling agent and cement mixture will sink to the bottom of a well fluid, and form a cohesive plug at the bottom where it comes to rest.

13. The cross-linked gelled settable fluid system of claim 9, wherein the system is derived by adding heavy-weight density-adjusting additives to the sodium silicate solution so that the hydrated water gelling agent and sodium silicate solution will sink to the bottom of a well fluid and not disperse, and form a cohesive plug at the bottom where it comes to rest.

14. A method of forming a plug using a cross-linked gelled settable system comprising:
a. hydrating a gelling agent;
b. adding the gelling agent to a hydraulic cement blend or sodium silicate solution, wherein the hydraulic cement blend or sodium silicate solution includes density modification additives and a cross-linking particulate substance;
c. adding the mixture of step “b” to any fluid of any density;
d. allowing the mixture of step “b” to matriculate through the fluid without dispersing to form a cohesive and stable plug wherever it comes to rest.

15. The method of claim 14 wherein the cross-linking particulate substance contains borosilicate bubbles.

16. The method of claim 14 wherein the cross-linking particulate substance contains crushed borosilicate glass.

17. The method of claim 14 wherein the cross-linking particulate substance comprises lightweight borosilicate bubbles, and the hydraulic cement blend with the gelling agent is added to a heavier fluid and allowed to matriculate through the fluid wherein the gelling agent and hydraulic cement blend form a slug of fluid which will not disperse and which will set or seal on top of the heavier fluid.

18. The method of claim 17 wherein the hydraulic cement blend and gelling agent is floated on top of the heavier fluid.

19. The method of claim 17 wherein the hydraulic cement blend and gelling agent is injected into the heavier fluid.

20. The method of claim 14 wherein the cross-linking particulate substance comprises borosilicate glass or borosilicate bubble and wherein the method further comprises placing the hydrated gelling agent and hydraulic cement blend in a fluid of any density wherein the hydrated gelling agent and hydraulic cement blend does not disperse and will form a plug where it comes to rest.

21. The method of claim 20 wherein the hydrated gelling agent and hydraulic cement blend is pumped into the top of a well or annulus, and allowed to fall through a fluid of lighter density to the top of a packer and allowed to set and seal the top of the packer.

22. The cross-linked gelled settable fluid system of claim 9 wherein the particulate substance contains crushed borosilicate glass or borosilicate bubbles.

23. A cross-linked gelled settable cement fluid system derived by pre-hydrating a cross-linkable water gelling agent, and then using that to mix with a hydraulic cement blend comprising density modification additives and a cross-linking particulate substance which results in a very stable hydraulic cement blend, which will matriculate through any fluid and not disperse, and form a cohesive plug wherever it comes to rest.
